(19) United States
(12) Patent Application Publication
(10) Pub. No.: US 2013/0189650 A1
(43) Pub. Date: Jul. 25, 2013

(54) BEAD AND PHOTO CRAFT AND RELATED SYSTEM AND METHOD

(71) Applicants: Wai C. Lee, Olathe, KS (US); Jonathan C. Burrell, Spring Hill, KS (US); Devon A. Rolf, Paola, KS (US); Abigail M. Rolf, Paola, KS (US)

(72) Inventors: Wai C. Lee, Olathe, KS (US); Jonathan C. Burrell, Spring Hill, KS (US); Devon A. Rolf, Paola, KS (US); Abigail M. Rolf, Paola, KS (US)

(73) Assignee: Olive Root, LLC, Paola, KS (US)

(21) Appl. No.: 13/358,378

(22) Filed: Jan. 25, 2012

(51) Int. Cl. G09B 11/00

(52) U.S. Cl. 434/81

(57) ABSTRACT

A method of providing a craft kit involves providing a kit including a frame with a window and a collection of beads presenting a plurality of colors and a pre-selected, fixed number of beads of each color. After providing the craft kit an image is received from a user. A bead template is generated by assigning a bead color to each of a plurality of bead positions on the template document to create a representation of the image using only beads from the collection of beads in the craft kit, and including a bead color indicator in each of said positions on the template document corresponding to the assigned bead color. Once the bead template document is created, it is transferred to the user to enable assembly of a bead array on the frame presenting the representation of the image.

### BACKGROUND

1. Field

Embodiments of the present invention relate to bead and photo crafts. More particularly, embodiments of the present invention relate to a bead and photo craft kit and method for creating a bead array presenting a representation of an image, wherein the bead array is assembled from a collection of beads including a preselected number of bead colors and a preselected number of beads of each color.

2. Related Art

The use of beads in arts and crafts is well known. Beads are commonly used to create decorative crafts and artwork, including to create pictures using different beads for different details and colors of the picture.

In craft or art projects involving the use of beads to create pictures, the type and number of beads used is driven by the particular picture the user is attempting to create. If a user is attempting to create a picture with a substantial portion of the picture being blue, for example, creating the picture may require the use of a disproportionately large number of blue beads.

Because the type and number of beads used to create pictures are dependent upon the particular picture and vary from one project to another, efficiently providing a single bead craft kit for use with multiple bead art projects is difficult, as the craft kit will lack some beads of a particular color, will include too many beads of another color, or both.

Accordingly, there is a need for a bead craft which overcomes these limitations.

### SUMMARY

A method of generating a template for a craft kit in accordance with an embodiment of the invention comprises receiving a plurality of bead color values and a number associated with each bead color value, wherein each number corresponds to a maximum number of beads of that bead color value to be used in the template. The method further comprises receiving an image, selecting a pixel from the image, and identifying one of the plurality of bead color values that has an associated number greater than zero and is closest in color to a color of the selected pixel. The identified bead color value is assigned to the selected image pixel and the number associated with the identified bead color value is reduced by one. A template is generated with the identified bead color value indicated in a position on the template corresponding to a position of the pixel in the image.

A method of generating a template for a craft kit in accordance with another embodiment of the invention comprises establishing a plurality of bead color values and a number associated with each bead color value, wherein each number corresponds to a number of beads of the associated bead color value to be used with the template, receiving dimension information of a bead array, receiving an image, and adjusting (such as by scaling) the image so that each of a plurality of image pixels corresponds to a bead of the bead array.

The method further comprises, for each of a plurality of image pixels, identifying a subset of the bead color values that has associated numbers greater than zero, selecting an image pixel and identifying one of the plurality of bead color values from the subset that is closest in color to a color of the selected image pixel, assigning the identified bead color value to the selected image pixel, and reducing by one the number associated with the identified bead color value.

A template document is generated with each of the assigned bead color values indicated in a position in the template document corresponding to a position of the associated pixel in the image.

A method of enabling assembly of a bead craft in accordance with yet another embodiment of the invention comprises providing a kit, the kit including a collection of beads including beads of each of a plurality of colors with a pre-selected, fixed number of beads of each color, and a frame for assembling a bead array from the collection of beads. After providing the craft kit, the method further enables processing an image for use in generating a bead template document, wherein the image is provided by a craft kit user. A bead template document is then generated for enabling assembly of the bead array on a window pane of the frame, wherein the template document is generated by assigning a bead color to each of a plurality of bead positions on the template document to create a representation of the image using only beads from the collection of beads in the craft kit, and including a bead color indicator in each of the positions on the template document corresponding to the assigned bead color. The bead template document is then transferred to the user.

In certain embodiments of the invention, the frame has a transparent or translucent back plate for holding the template document between the front window and the back plate. The template is itself made of a transparent or translucent substrate and the colored beads in this embodiment are transparent or translucent. Accordingly, light from a window or lamp may pass through from the rear of the frame through the back plate, the template, the front window of the frame the beads.

In certain embodiments of the invention, a camera, such as a digital camera, is provided at a physical retail location, such as a retail store, booth at an arts and/or crafts festival, or cart or kiosk in a mall. A photograph is taken of the purchaser of a craft kit at the retail location and a template is generated and printed for the bead craft and provided to the purchaser at the retail location. Such embodiments of the invention may be self-service or implemented with the aid of a staff person at the retail location. The printed template may be placed in a box of the craft kit and/or placed directly in the frame, which may in turn be placed in the box.

In certain embodiments of the invention, the template is printed with visual representations of the locations at which to place the beads to serve as a guide for bead placement. In particular, the template may include circles each having a diameter corresponding to the diameter of the beads. A numerical indicator indicative of the bead color to locate in a particular circle may be printed within the circle. Additionally, each circle may be printed in a color corresponding to the bead color to be placed at the location of the circle. Additionally, the space outside each circle corresponding to the diameter of the circle may be colored or shaded including being colored or shaded with a color corresponding to the bead color to be placed at the location of the circle.

Additionally, in certain embodiments, statistical data of the colors in images, uploaded to a website of the invention, for which templates are generated is maintained, analyzed, and used to adjust bead count and/or bead colors in the bead craft kit of the present invention.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWINGS

FIG. 1 is a schematic diagram of exemplary computer and communications equipment that may be used to implement certain aspects of the present invention;

FIG. 2 illustrates the components of a craft kit according to an embodiment of the present invention;

FIG. 3 illustrates the components of the craft kit of FIG. 2 organized for assembly in a box for distribution or sale;

FIG. 4 is a flow diagram depicting an exemplary method of assembling the craft kit of FIG. 2 and FIG. 3;

FIG. 5 illustrates the craft kit of FIG. 3 assembled in a box for distribution;

FIG. 6 is a flow diagram depicting an exemplary method of using the craft kit of FIG. 5 to create a bead and photo craft;

FIG. 7 is a flow diagram depicting an exemplary method of creating a bead template for use with the craft kit of FIG. 5;

FIG. 8 is a plurality of screenshots of an exemplary website for enabling a user to submit an image and create the bead template for use with the craft kit of FIG. 5;

FIG. 9 illustrates certain steps involved in the assembly of the craft kit of FIG. 5, including applying an adhesive to a portion of a frame and fixing beads to the adhesive according to a bead pattern presented by the bead template;

FIG. 10 is a bead container or tray constructed according to an alternative embodiment of the invention with bead identifiers presented on an outer surface of the bead container and bead compartments configured to facilitate removal of the beads from the container; and

FIGS. 11a and 11b illustrate templates produced according to alternate embodiments of the invention as illustrated in an enlarged view with printed bead guides and shading.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention may be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

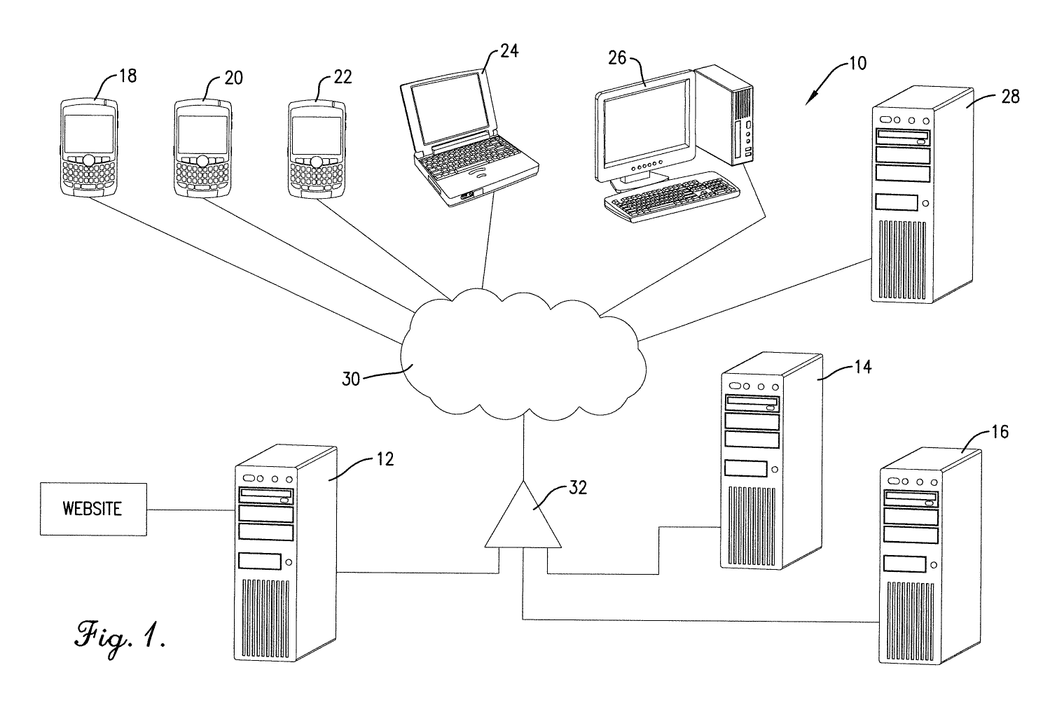

Certain aspects of the present invention can be implemented in hardware, software, firmware, or a combination thereof. In one exemplary embodiment, aspects of the invention are implemented with a computer program or programs that operate computer and communications equipment broadly referred to by the numeral 10 in FIG. 1. The exemplary computer and communications equipment 10 may include one or more host computers 12,14,16 and a plurality of electronic devices 18,20,22,24,26,28 that may access the host computers via a communications network 30. The computer programs and equipment illustrated and described herein are merely examples of programs and equipment that may be used to implement aspects of various embodiments of the invention and may be replaced with other programs and computer equipment without departing from the scope of the invention.

The host computers 12,14,16 may serve as repositories for data and programs used to implement certain aspects of the present invention as described in more detail below. The host computers 12,14,16 may be any computing devices such as network or server computers and may be connected to a firewall to prevent tampering with information stored on or accessible by the computers. The functionality of the host computers may also be distributed amongst many different computers in a cloud computing environment.

One of the host computers, such as host computer 12, may be a device that operates or hosts a website accessible by at least some of the devices 18-28. The host computer 12 includes conventional web hosting operating software, an Internet connection such as a cable connection, satellite connection, DSL converter, or ISDN converter, and is assigned a URL and corresponding domain name so that the website hosted thereon can be accessed via the Internet in a conventional manner.

The host computers 14,16 may host and support software and services of proprietary mobile application providers such as Google, Apple, and Blackberry. For example, the host computer 14 may support Google Android mobile applications and the host computer 16 may support Apple iPhone mobile applications.

Although three host computers 12,14,16 are described and illustrated herein, embodiments of the invention may use any combination of host computers and/or other computers or equipment. For example, the features and services described herein may be divided between the host computers 12,14,16 or may all be implemented with only one of the host computers.

The computer and communications equipment 10 may also include or use a data interchange format device 32 for distinguishing the types of devices (e.g. mobile phone, desktop computer) that attempt to access the host computers 12,14,16 and for routing communications and requests to the host computers accordingly.

The electronic devices 18-28 may be used by bead craft purchasers or users and/or others wishing to view, receive, and/or provide information described herein. The electronic devices 18-28 may be any type of devices that can access the host computers 12,14,16 via the communications network 30. Each electronic device 18-28 preferably includes or can access a web browser and a conventional Internet connection, such as a wireless broadband connection, a modem, DSL converter, or ISDN converter that permits it to access the Internet.

The electronic devices 18-28 may include, for example, one or more mobile communications devices 18,20,22, such as wireless phones, smartphones, phone-enabled personal digital assistants (PDAs), tablet computers, MP3 devices, handheld game players, or any other mobile or wireless communication device. Such mobile communication devices may be operated by bead craft purchasers or users as discussed in more detail below.

The electronic devices 18-28 may also include one or more laptop, personal, or network computers 24,26,28 operated by one or more bead craft purchasers or users as discussed in more detail below. Although FIG. 1 depicts a particular number of electronic devices 18-28, any number of devices may access the host computers 12,14,16.

The communications network 30 is preferably the Internet but may be any other communications network such as a local area network, a wide area network, a wireless network, or an intranet. The communications network 30 may also be a combination of several networks. For example, the electronic devices 18-28 may wirelessly communicate with a computer or hub via a Wi-Fi network, which in turn is in communication with one or more of the host computers 12,14,16 via the Internet or other communication network.

The computer programs of the present invention are stored in or on computer-readable medium residing on or accessible by the computer and communications equipment 10. The computer programs preferably comprise ordered listings of executable instructions for implementing logical functions in the host computers 12,14,16 and/or devices 18-28. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

As explained above, aspects of the invention may be implemented with a computer program or programs, also referred to herein as “software,” that operate computer equipment. Software generally refers to a set of statements or instructions to be used directly or indirectly in one or more computers in order to bring about a certain result. For the benefit of convenience, reference will be made herein to software “performing” certain functions with the understanding that the function is performed by one or more computers or other electronic devices using or running the software.

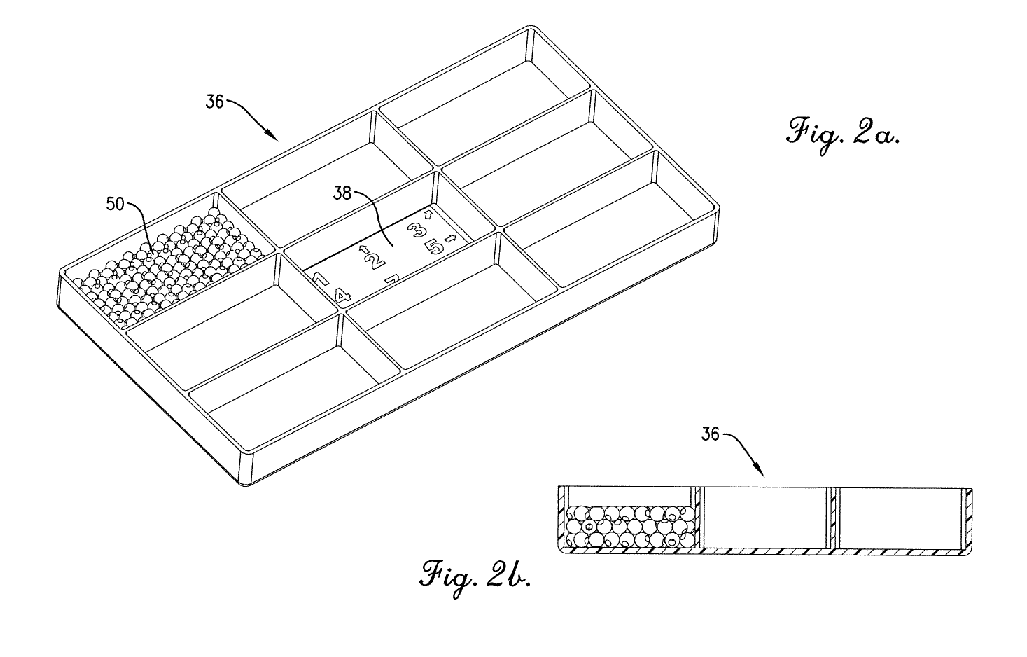

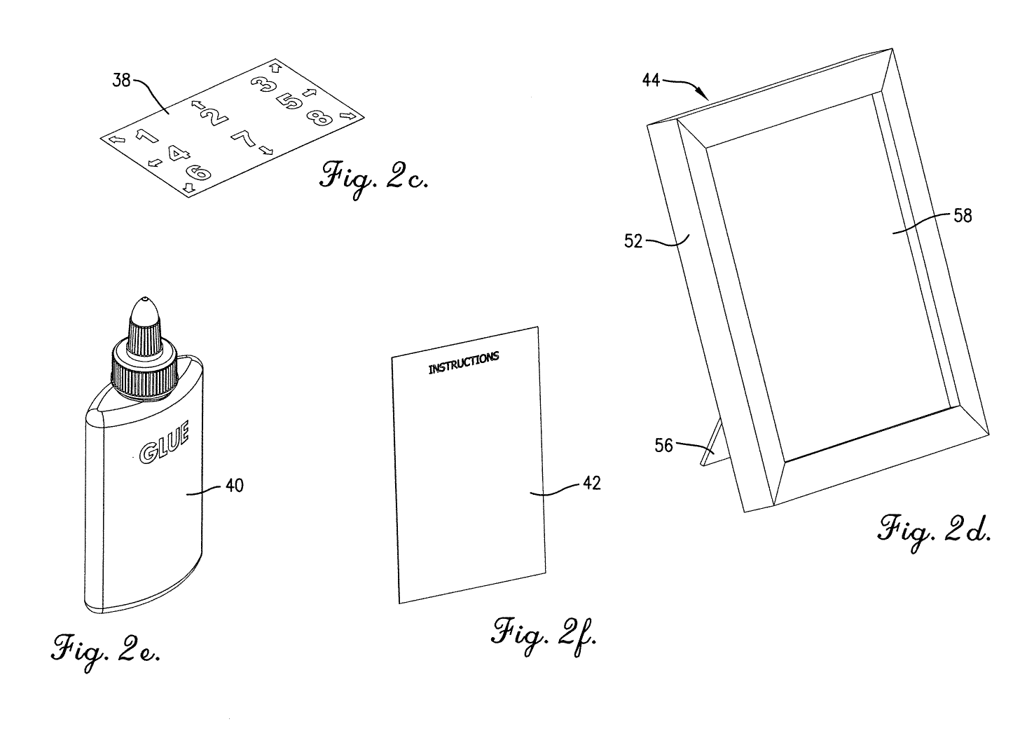

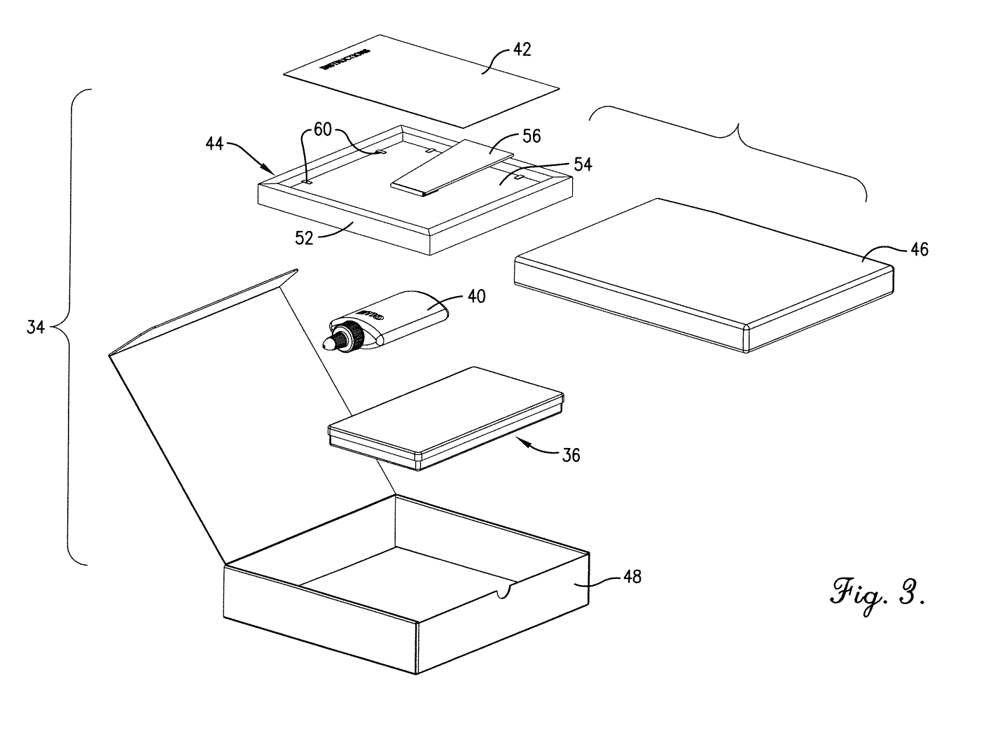

With reference now to FIGS. 2a-f and 3, a craft kit 34 constructed in accordance with an embodiment of the invention is shown. The craft kit 34 generally includes a bead container 36, a bead identifier key 38, a container of adhesive 40, a set of instructions 42, a frame 44, and protective material 46 for the frame 44. The craft kit components may be contained in a box 48 for distribution and sale. In accordance with one embodiment of the invention and as explained below in greater detail, the craft kit 34 is packaged and sold to consumers who then may access or use software to generate a bead array template document for use with the bead craft kit. As used herein, a “photo” is an image and may include, for example, an analog or digital photograph.

The bead container 36 may include a plurality of sections for holding beads 50 of two or more colors. For example, each section of the container 36 may hold beads of a particular color. The illustrated container 36 includes nine sections each operable to hold a plurality of beads. If one section is used to hold the bead identifier key 38, eight sections may be used to hold beads, such that the container 36 includes beads of eight different colors. Alternatively, the bead identifier key 38 may be configured for use outside of the container 36, such that all nine sections may be used to hold beads. In accordance with one exemplary embodiment of the invention, there are eight bead colors arranged in container sections with a middle or central section housing bead identifier key 38 which includes numerals corresponding to bead colors and arrows for designating each container section with a corresponding bead color. In one exemplary embodiment, bead container 36 is constructed of transparent, molded plastic.

The container 36 may include the same number of beads of each color, or may include a different number of beads of different colors. Furthermore, if there is a large number of beads of a particular color, those beads may be placed in two or more sections of the container to accommodate the larger number. While the present teachings contemplate virtually any number of container sections, any number of bead colors, and any number of beads of each color, an exemplary embodiment of the invention preferably includes between six and twelve bead colors, and more preferably between eight and ten bead colors, and includes between fifty and four hundred beads of each color. In accordance with one embodiment of the invention, there are a fewer number of beads of at least one of the lightest colored bead and the darkest colored bead in the kit 34.

For purposes of illustration, the bead container 36 in FIG. 2 includes beads in only one section. When the kit 34 is packaged for distribution or sale, however, the container 36 will typically include a plurality of colors of beads, such that beads are included in all or most of the sections of the container 36. Because the beads 50 are included in the craft kit when it is assembled and sold, the number and color of beads 50 in each craft kit 34 is fixed at the time of sale and before the user selects an image and generates a template document, as explained below.

A fill level or “height” of the beads 50 in each section of the container 36 is less than or equal to approximately 90% of a height of the section, less than or equal to approximately 75% of the height of the section, or less than or equal to approximately 60% of the height of the section. This helps to prevent beads 50 from falling out or otherwise escaping a particular section when the user places their fingers in the section to grasp or secure a bead.

The colors represented by the beads 50 may be chosen specifically to accommodate an intended image type. For example, if the craft kit 34 is sold specifically for use with portraits, the bead colors may be chosen to represent various hair colors and skin tones, including skin tones associated with persons of different ethnic backgrounds. If the craft kit 34 is sold specifically for use with landscape images, the bead colors may be chosen to best represent landscape colors, including colors associated with foliage and sky.

In particular, according to one aspect of the present invention, when the craft kit 34 is designed for facial portraits, hands, etcetera and skin and/or hair tones are used, the colors for the beads are chosen so as to be at least substantially evenly spaced across a color spectrum of common skin and hair colors ranging from light to dark.

In accordance with an aspect of the present invention, craft kit 34 includes a sufficient number of beads 50 of each bead color to create a portrait with any conventional hair and/or skin tones. For example, bead craft kit 34 would include a sufficient number of beads 50 of each color to create a meaningfully photorealistic beaded portrait of a light-skinned Caucasian with blonde hair. The same craft kit 34 would also include a sufficient number of beads 50 of each color to create a meaningfully photorealistic beaded portrait of a dark-skinned African-American with black hair. Similarly, the same craft kit 34 would have a sufficient number of beads 50 of each color to create a meaningfully photorealistic beaded portrait of an olive skinned brunette, persons of Asian or Hispanic descent, etcetera. In particular, rather than utilizing significantly more beads 50 than are needed to accommodate different hair and skin colors, the beaded portrait resulting from using the craft kit 34 may have somewhat of a Sepia appearance, thereby making it applicable to a wide-array of skin/hair tones. Additionally, the dithering techniques described herein—the mixing of beads of different colors in close proximity to each other—provides an illusion of a desired color or shading, thereby enabling use of an efficient number of beads of each color and preventing the need for significantly overstocking beads of each color in the craft kit to accommodate many different images.

In accordance with another aspect of the invention, bead colors are chosen based upon a selected image, such as a selected digital photograph. For example, a digital photograph of a flower, such as a red rose, is taken and analyzed for color. Given the particular shading, light conditions, etcetera, a typical red rose will actually have a plurality of red tones, ranging from light pink, to red, to deep red and even to a black or almost black appearance in the darkness of the folds between the petals of the flower. Additionally, a stem of the rose may have various shades of green. Accordingly, for example, as the result of a color analysis on a close-up of a rose for the purpose of selecting a color pallet for bead craft 34, a color palette for a red rose may be selected to have two shades of green, four shades of pink/red, a black and a brown, for example. Once these colors are selected, beads 50 can be made to correspond to the selected colors. While it will be understood that bead craft kit 34 may be used to make a wide variety of different beaded portraits, examples of specific beaded portraits for which bead craft kit 34 may be tailored include living items such as people, plants or animals or portions thereof (examples for illustrative purposes include a person's or peoples' face(s), hands, or feet, dogs, cats, birds, horses, butterflies, flowers, trees, etcetera) or formerly living items (such as dried flowers, leaves, fruits and vegetables, etcetera). A representation of a digital photograph used to create a template may be include in craft kit 34.

As used herein, a “bead” is a physical element used to create a representation of an image. The beads 50 may be substantially uniform in size and shape or may vary in size and/or shape, and may be spherical, partially spherical (such as, for example, cabochons), faceted or non-faceted, or may even present a cube or cone shape. The beads may be made of any suitable material, such as glass, plastic, or wood, and may have through-holes or be no-hole beads. The beads may be opaque or translucent and, in some instances, completely transparent. The beads may be textured or smooth and have a glossy, semi-glossy, or matte finish. In one embodiment, the beads 50 are each preferably between two and eight millimeters in diameter (or across, if not spherical), more preferably between three and six millimeters, and may particularly be about four or about five millimeters in diameter/across.

The frame 44 provides structure for the assembly of the bead array and displays the completed bead array. The frame 44 may be similar to a traditional picture frame and may include a rigid perimeter 52 made of wood, plastic or other rigid material, a sturdy back panel 54 including mounting or support elements 56, and a front-facing glass or plastic pane 58 that is transparent or partially transparent. The frame 44 may include a plurality of tabs 60 or other retaining means for retaining the back panel 54 in position proximate or against the pane 58. The retaining means 60 allows the back panel 54 to be removed and replaced to, for example, allow the user to place the template between the back panel 54 and the pane 58. In one embodiment, described further below, the back panel 54 is transparent, such as glass or clear plastic. In another embodiment, also described further below, the frame 44 does not have a back panel.

The frame 44 may be of virtually any size and shape, including conventional sizes such as eight inches by ten inches, five inches by seven inches, or three inches by five inches. In one exemplary embodiment, the frame 44 presents a rectangular shape, wherein the pane 58 has a length and a width each preferably within the range of from about 120 millimeters to about 220 millimeters, more preferably within the range of from about 160 millimeters to about 180 millimeters.

The container of adhesive 40 may be a bottle of conventional glue operable to secure the beads 50 to the pane 58. Preferably, the container of adhesive 40 is a container of high tack, transparent gel glue that applies clear and dries clear. Thus, the adhesive 40 is preferably applied in transparent, liquid form and is sufficiently strong to hold the beads 50 in place when dried. Other adhesive materials may be used without departing from the scope of the invention including, for example, adhesive tape.

The set of instructions 42 may be included in the kit 34 with directions for creating the template and assembling the bead array. As explained below in greater detail, the instructions 42 include directions for inserting the template into the frame 44 and creating the bead array by fixing the beads 50 to the pane 58 using the adhesive 40 according to a bead pattern presented on the template. The instructions 42 may be in the form of an instruction sheet or instruction manual. Alternatively, the set of instructions 42 may be accessible electronically via, for example, a webpage accessible via the Internet, an electronic communication, and so forth.

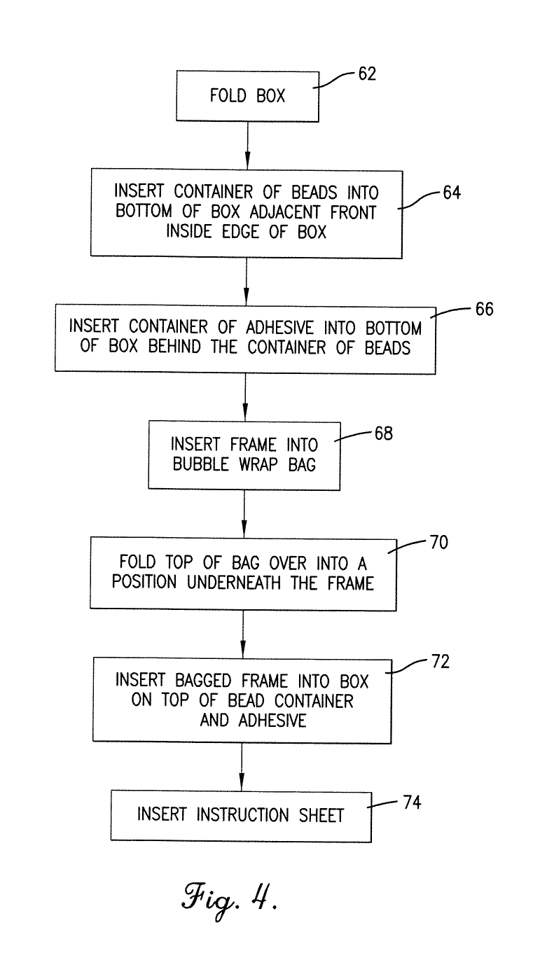

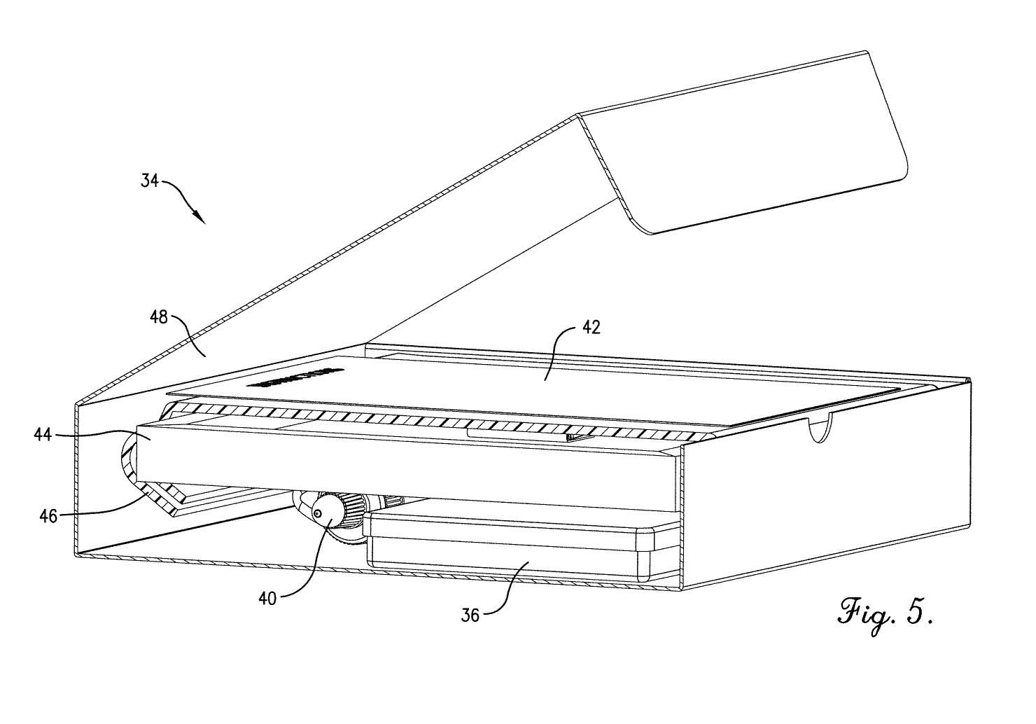

An exemplary method of assembling the craft kit 34 for distribution, sale or both is depicted in the flow diagram of FIG. 4. The box 48 is first folded into shape, as depicted in block 62. The box 48 may be created from a sheet of cardboard or similar material that is stamped, cut, or otherwise prepared to be folded into the shape illustrated in the drawings. The bead container 36 is inserted into the box 48 such that the container 36 is adjacent a front inside edge or surface of the box 48, as depicted in block 64, and the container of adhesive 40 is inserted into the box 48 behind the bead container 36, as depicted in block 66. As depicted in block 68, the frame 44 is inserted into bubble wrap bag 46 or similar protective packaging, and the top of the bag is folded into a position underneath the frame 44, as depicted in block 70, thereby aiding in keeping the container of adhesive 40 (or the bead container 36) from significantly shifting during transportation. It will be appreciated that the bead container 36 may be placed proximate a different inside edge or surface of the box 48 with the container of adhesive 40 adjacent the bead container 40 (separated by a divider or not) in the bottom of the box 48. The frame 44 is then placed in the box 48 on top of the bead container 36 and the container of adhesive 40, as depicted in block 72, and the set of instructions 42 is placed on top of the frame 44, as depicted in block 74. The assembled kit 34 is depicted in FIG. 5. Other packing materials, packaging inserts and dividers, and packing methods may be used without departing from the scope of the invention.

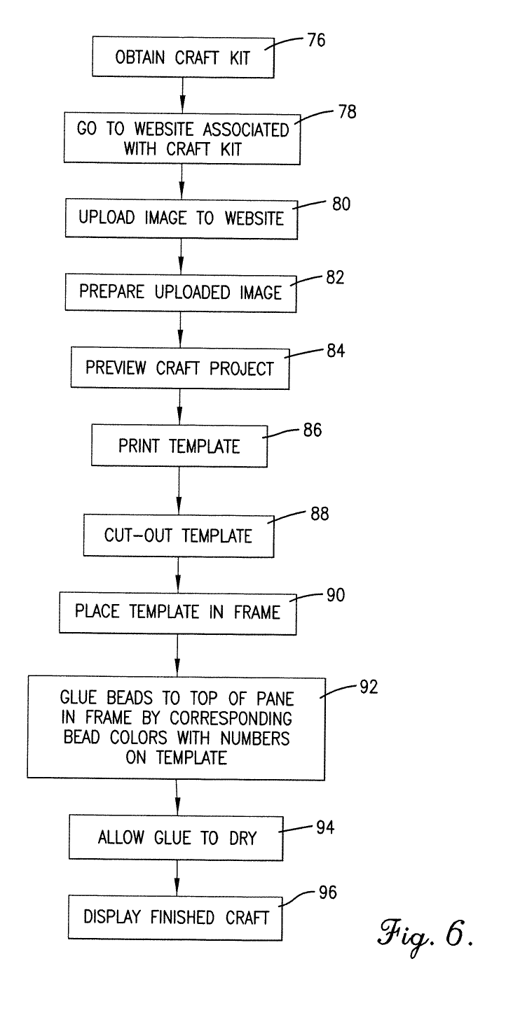

An exemplary method of using of the craft kit 34 to assemble a bead array is depicted in the flow diagram of FIG. 6. A user first obtains the craft kit 34, as depicted in block 76. The user may obtain the kit 34 by, for example, purchasing the kit 34 from a retail store, through an on-line retailer, or similar method. Once the user has obtained the kit 34, he or she may reference the set of instructions 42, which may describe the following steps. The user accesses a website associated with the craft kit 34, as depicted in block 78. The user may access the website using, for example, one of the devices 18-22 or one of the computers 24-28. By accessing the website, the user has access to software for creating a bead array template. Once at the website, the user follows instructions on the site and uses site utilities to upload an image to the site, as depicted in block 80. The user may select an image that he or she created using a digital camera or scanner, for example, or an image obtained from another source.

In one embodiment, the craft kit 34 and the software are configured specifically for use with a particular type of image, such as a portrait, wherein the beads 50 in the craft kit 34 include colors associated with portrait images, such as skin tone and hair color, and the software may include filters and functions associated with portrait processing, such as facial recognition and red eye removal. In other embodiments, the craft kit 34 and software may be configured specifically for use with other types of images, such as landscapes or sunsets, fruit, vegetables, animals, plants, and so forth. In yet another embodiment, the craft kit 34 is configured for general use wherein the bead colors do not correspond to any particular type of image.

Once the image is uploaded to the website the image is prepared, as depicted in block 82. For image preparation, the software may enable or perform manual or automated (or both) image manipulation and processing. By way of example, the software may enable the user to crop the image, may suggest a cropping action, or may automatically crop the image based on, for example, automated facial recognition. If the software enables manual cropping, the software may assist the user by providing visual feedback or guidance. The software may enable or perform virtually any image processing or manipulation function including, for example, brightness and contrast adjustment, as well as image stretching, skewing, and resizing to name a few. The software may further be configured to analyze the image to determine whether it is adequate for use with the craft kit 34. If the software is configured for use with portraits, for example, the software may determine the size of the face in the image, the color spectrum associated with the face or with the entire image, the level of detail present in the face or in the entire image, or any combination of these attributes, and suggest or require a new image if the uploaded image is not sufficient. By way of example, the software may suggest or require a new image with more facial detail, such as a new image with a “close up” of a subject's face. By further way of example, an auto-contrast function of the present invention may adjust the contrast of an uploaded image, before or after it is cropped or scaled, so that it has a selected number or percentage of one or more particular colors. In particular, the present invention may adjust the contrast of an uploaded image so that at least one, a selected number, or a selected percentage of each color in the bead color palette is used in the craft. In this way, if an image is too dark, it can be automatically lightened or vice versa. Additionally, if an uploaded image is too monochromatic, contrast adjustments can be made in an effort to distribute the color of the image across the palette. Additionally, it is an aspect of the invention to provide a recommendation to user that a particular image is too light, too dark, or too monochromatic to result in a desirable craft according to the present invention.

According to one aspect of the invention, the website of the present invention provides one or more slide interfaces that can be dragged with the aid of a user-input, such as a touch screen or computer mouse, that enables the brightness and/or contrast of the image to be adjusted. Such interfaces can be used in conjunction with the preview feature described below to enable the user to adjust an uploaded, input image to a desired appearance. Additionally, adjustments make an image appear too light or dark, such as determined by a number or percentage of pixels in particular categories, may produce an out of range message or other recommendations to the user. According to one aspect of the invention, the slide interface enables a scaled image to be adjusted only within the parameters of a bead count for each color of the scaled image or slightly beyond one or more bead counts up to a preprogrammed threshold, since the color dispersion techniques of the present invention, described below, can provide some accommodation for a bead count that has gone to zero.

Once the image is prepared, the software generates a template based on the image for use with the craft kit 34. The template generally provides a visual pattern for placing the beads 50, such that the resulting bead array presents an appearance similar to the image. The process of generating the template from the image is discussed below.

The software presents to the user a preview of the craft project, as depicted in block 84. The preview may include presenting an image of the template, a depiction of the anticipated finished bead project, or both. The software may generate a depiction of the anticipated finished bead project by, for example, building an image of a bead array corresponding to the bead pattern presented in the template and the colors of the beads 50 in the craft kit 34. The software may use actual images of the beads 50 to build the image, or may generate images of the beads 50 similar to the actual appearance of the beads. If the user is not satisfied with the preview, he or she may make changes by, for example, uploading a different image or further manipulating the image, such as by cropping the image differently. The preview(s) provided may be shown in a small area of the display screen or the present invention may provide an interface, such as a slide interface, to enable the user to adjust the viewing size of the preview(s). For example, by viewing a small displayed image of a preview the user will have a better representation of a view of the template or craft from a distance.

When the user is satisfied with the preview, he or she generates or requests a hard copy of the template by, for example, printing a copy of template as depicted in block 86. The user may print a copy of the template directly from the website or may request an electronic template document to be stored locally on an electronic device. The hard copy of the template includes indicia for bead placement on at least one side of the template. The user may print a copy of the template directly from the website, may download an electronic copy of the template document, or otherwise receive an electronic copy of the image document for storage, printing or both.

Once the user has a hard copy of the template, he or she may cut out or trim the template, as necessary, as depicted in block 88. The user places the template in the frame 44, as depicted in block 90, such that the indicia for bead placement is visible through the pane 58 and enables the user to place the beads 50 on the pane 58 following the visual bead array pattern presented in the template document. The hard copy of the template may be placed in the frame 44 in a conventional manner, for example, wherein the back panel 54 is removed from the frame 44, the template is placed against an inside surface of the pane 58, and the back panel 54 is replaced in the frame 44 against the template.

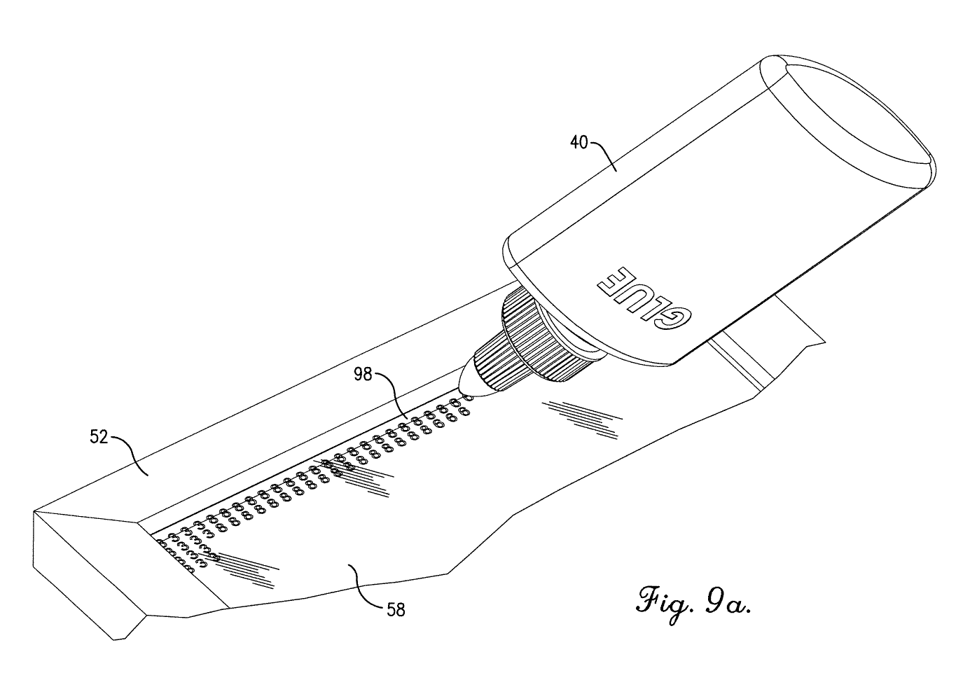

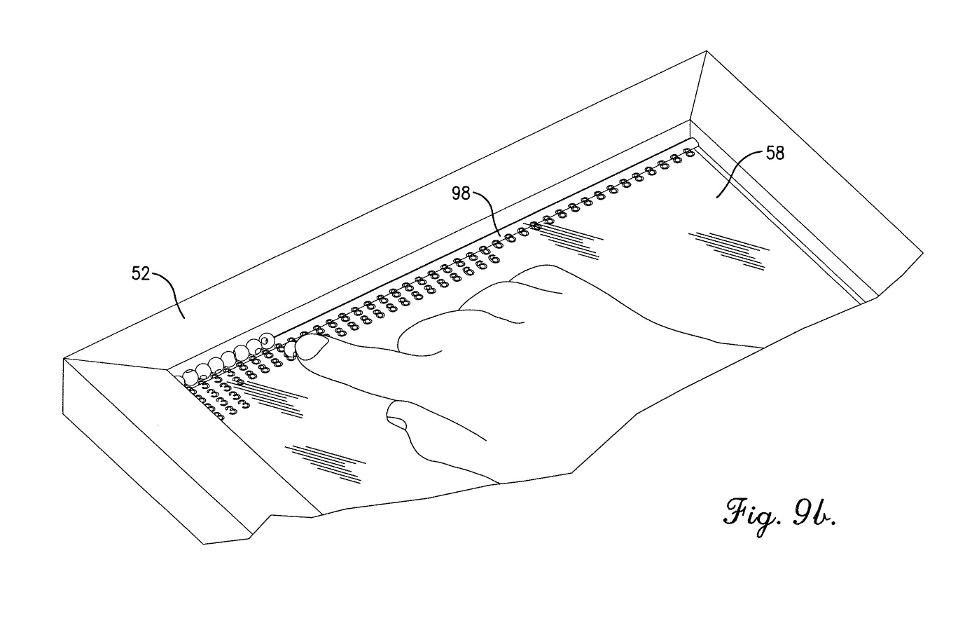

With the template placed in the frame 44, the user assembles the bead array by fixing the beads 50 to the pane 58 according to the pattern presented in the template, as depicted in block 92. As illustrated in FIG. 9, the bead array may be assembled in a process wherein adhesive 98 is applied to a first portion of the pane 58 and beads 50 are placed on the adhesive 98 according to the template pattern corresponding to the first portion of the template. The process is repeated until the bead array has been completely assembled. By way of example, adhesive 98 may be applied to a portion of the pane corresponding to a row of beads, wherein the beads are placed on the adhesive 98 according to the bead indicia corresponding to that row. In the illustrated embodiment, adhesive 98 is applied to a portion of the pane corresponding to a first or top row of beads, and beads are placed on the adhesive 98 according to the indicia corresponding to the first row. The illustrated first row of indicia on the template includes bead numbers “3,” “8” and “6.” This process is repeated for each row until all rows have been completed and the bead array is finished. The adhesive is then allowed to dry or harden, if necessary, as depicted in block 94. The finished craft may then be displayed, as depicted in block 96. The finished craft may be displayed by, for example, hanging the frame on a wall or setting the frame on a desk, table or other surface. The template may be removed or left in the frame according to the preferences of the user.

In accordance with an alternate embodiment of the present invention, the back panel 54 of frame 44 is transparent, such as glass or clear plastic. Additionally, in this embodiment, the template is preferably transparent or translucent and the indicia on the template representative of bead colors to locate in particular locations are preferably printed in light tones. In this embodiment, the beads 50 are preferably translucent, enabling light to pass through them. A finished bead craft of this embodiment may thus be placed in front of a window or lamp and light will pass through the transparent back panel and the template and the translucent beads. In a variation of this embodiment, a transparent or translucent template is adhered directly to the pane 58, such as the rear of the pane 58, of frame 44. Alternatively, a template, which does not need to be transparent or translucent, can be temporarily adhered, such as by taping, to the rear of pane 58 and then removed once all beads 50 are adhered in place on the front of the pane. It will be understood that, in alternate embodiments, the beads can be adhered to the rear of pane 58 and/or directly on top of and to the template. For example, in one exemplary variation of the present invention, the template may be placed upside down in a temporary fashion on the front of the window pane and the beads adhered to the rear of the window pane. When all beads are placed, the template can be removed. It should also be understood that frame 44 may have small hooks or loops to which ends of a chain or rope are fastened so that the finished bead craft may hang, from a hook, in front of a window or lamp.

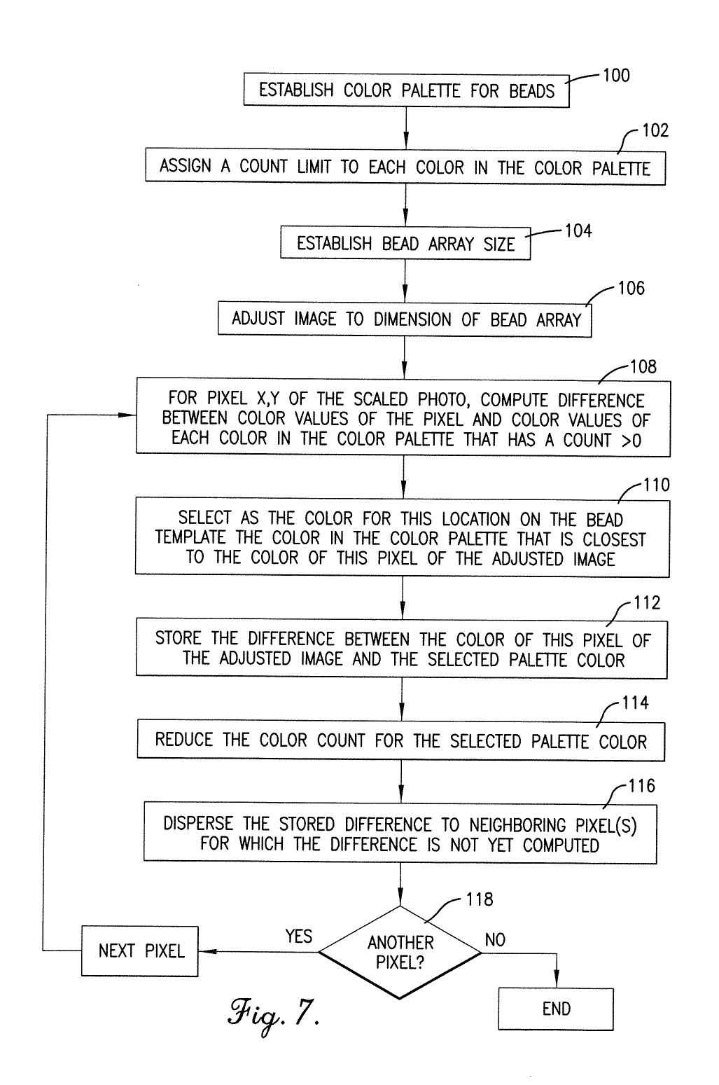

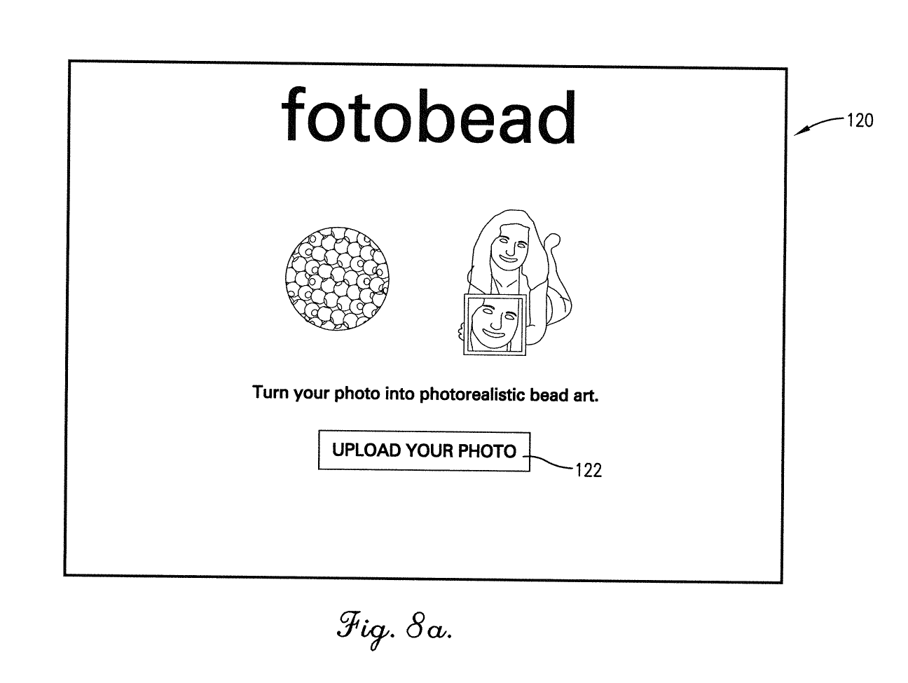

An exemplary process for generating the template is illustrated by the flow diagram of FIG. 7. A color palette is first established for the beads, as illustrated in block 100. The color palette is a list of bead color values corresponding to colors of the beads in the bead container 36. The color palette is established when the software has access to the list of colors in a form useable by a computer running the software.

A count limit is assigned to each color of the color palette, as depicted in block 102. The count limit corresponds to the maximum number of beads of each color that could be used in the bead array and, correspondingly, that could be represented in the template. The count limit for each color may correspond precisely to the number of beads of the corresponding color present in the craft kit, or may be slightly less to accommodate lost or damaged beads. The count limit for each bead color may be preprogrammed into the software or may be provided as a software component or data file accessible by the software. The particular method or process of establishing the count limits may vary from one embodiment of the invention to another without departing from the scope of the invention.

A bead array size is established, as illustrated in block 104. The bead array size may include one or more dimensions of the bead array expressed in terms of, or corresponding to, a number of beads. If the bead array is rectangular in shape, for example, the bead array size may include a number of beads corresponding to a width of the array and a number of beads corresponding to a length of the array. Bead arrays of various shapes and sizes may be used without departing from the scope of the invention.

Both the color palette and the bead array size may be preprogrammed into the software or may be provided as a software component or data file accessible by the software. The particular methods or processes of establishing the color palette and/or bead array size may vary from one embodiment of the invention to another without departing from the scope of the invention.

The image is adjusted to match the dimensions of the bead array, as depicted in block 106. This step involves manipulating the image so that individual image picture elements or “pixels” correspond to particular beads or bead positions of the bead array. A large image may be reduced in size and stretched, for example, such that the number of pixels along a length of the image corresponds to the number of beads along a length of the bead array, and the number of pixels along a width of the image corresponds to the number of beads along a width of the bead array. Similarly, a small image may be enlarged to match the dimensions of the bead array.

It will be appreciated by those skilled in the art that adjusting the image such that each image pixel corresponds to a bead in the bead array is just one exemplary method of mapping the image to the bead array that may be used by the present invention. An alternative approach may be used, for example, that involves creating regions of the image corresponding to particular beads of the bead array, wherein each region is associated with a particular color and corresponds to a particular bead of the bead array or position on the bead array template.

The software scans the pixels of the adjusted image and stores one or more color values for each pixel, as depicted in block 108. The color values may be stored in a data structure within memory accessible by the software to facilitate, for example, using the color values in the subsequent process steps. Both the bead color values and the pixel color values may be numeric values defining a color, and may include a plurality of numeric values corresponding to components of the respective pixel or bead color. By way of example, each of the bead color values and the pixel color values may include numeric values corresponding to red, green and blue components of a respective composite color value.

For a selected pixel from the adjusted image, the software compares the color of the selected pixel to each color of the color palette that has a count limit greater than zero, as illustrated in block 108. This comparison may involve comparing numeric color values, such as Red (R), Green (G) and Blue (B) values associated with the selected pixel with numeric color values associated with each of the colors of the color palette and recording a difference between the two numeric values. The software identifies a bead color value from the color palette that is closest to the color of the selected image pixel and assigns the identified bead color value to the selected pixel, as illustrated in block 110.

The software stores the difference between the color of the selected image pixel and the identified bead color value from the color palette, as depicted in block 112. The difference may be stored as one or more numeric values corresponding to differences between numeric representations of the image pixel color and the selected palette color. By way of example, if the image pixel color and the selected palette color are each represented with numeric values corresponding to red, green and blue components thereof, the difference between the two colors may be expressed and stored as a numeric values representing the difference between the red, green and blue components of each number.

The color count corresponding to the selected bead color is reduced by one, indicating that one less bead of that color is available for use in the template, as depicted in block 114.

The software may disperse the stored difference in color to neighboring pixels for which the difference is not computed, as depicted in block 116. This step, which may be referenced as a dithering step, may be performed to offset the difference in color between the selected pixel and the identified bead color, thereby strategically placing bead colors in the bead array such that the representation of the image in the bead array more closely matches the color of the image. If the software selects a pixel in a corner of the image as the first pixel to be processed, for example, the software may determine that the closest color from the color palette is lighter than the color of the selected pixel and determine that the difference in color is represented by a number N. If neighboring pixels are similar in color to the selected pixel, it is likely that the same bead color will be identified for each of the neighboring pixels, wherein the identified bead color in each case is lighter than the corresponding image pixel color with a similar color difference value. This would result in the portion of the bead array corresponding to the selected pixel and neighboring pixels being lighter in color than the corresponding portion of the image. To prevent this from happening, the software may “disperse” the difference N to neighboring pixels by adjusting the target color of neighboring pixels to offset the difference associated with the selected pixel. In the example set forth above, this may involve assigning bead colors to those pixels that are darker than the respective pixel color by a difference of N, such that the combined effect of the lighter bead color corresponding to the selected pixel and the darker bead color corresponding to the neighboring pixels is a group of beads that appear to present a color similar to the corresponding group of pixels.

For example, each pixel in a scaled image utilized with the present invention may have a Red (R), a Green (G), and a Blue (B) component, as will be readily understood. Assume, for example, that a particular pixel is a bit darker than the nearest bead color in the bead color pallet. Although the particular pixel will be assigned the nearest bead color, the photorealistic bead craft of the present invention will actually be a bit lighter in this region than the actual image. Accordingly, the difference between the color of the pixel and the actual bead color may be stored and distributed to neighboring pixels. In particular, since it is now desired to offset the lightened appearance, the invention may attempt to darken the next neighboring pixel in an amount corresponding to the color difference stored for the preceding pixel. So, the RGB value of the next pixel is determined and then adjusted to be darker by an amount of the stored difference corresponding to the last pixel. This new, adjusted color is then compared with the bead colors in the bead palette and the pixel location is assigned a bead color that is closest to this adjusted color value. Again, for this pixel, a difference is calculated (whether lighter or darker) and dispersed to the next pixel. In a preferred embodiment, color differences between a particular pixel and an actual, selected closest bead color are dispersed to neighboring pixels in a weighted distribution. For example, 40% of the difference is distributed to the next pixel in a row, 30% of the color difference is distributed to the pixel under it, 15% of the difference is distributed to the lower left pixel, and 15% is distributed to the lower right pixel. Other distribution percentages can be employed and pixels on an edge may employ different rules or differences may roll over to the next row (or column, depending on implementation). Color difference and addition computations are well established art.

The software tracks which pixels have been processed and determines whether any pixels remain for processing, as depicted in block 118. If so, another pixel from the image is selected and processed. If all pixels have been processed, pixel processing is ended. Once pixel processing is complete, the software may present a preview of the template, the assembled bead array, or both, and may present the template for printing.

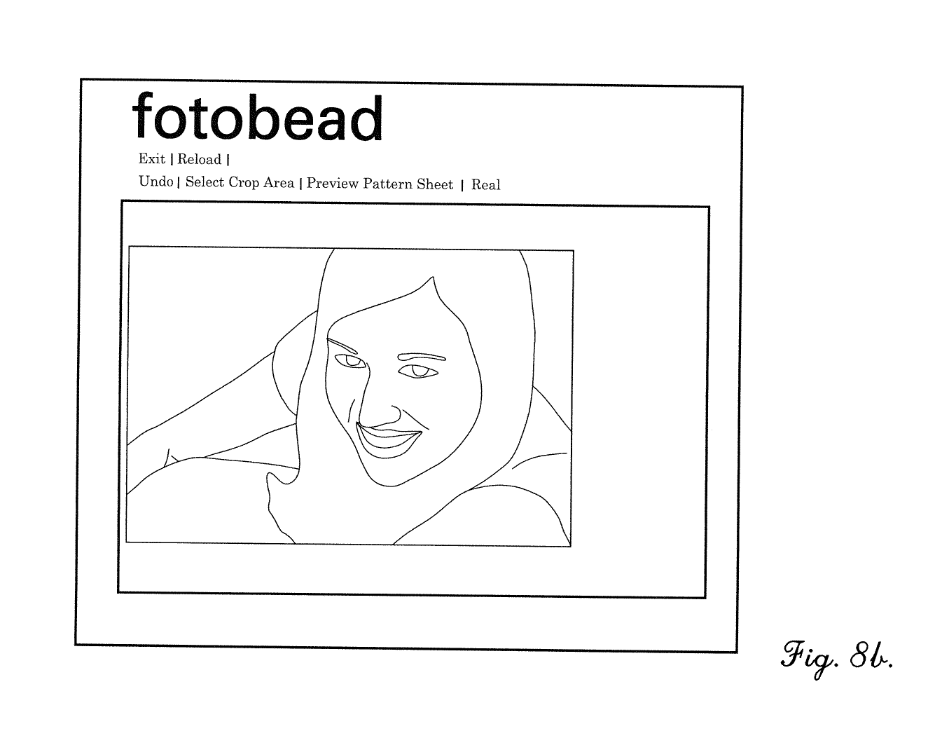

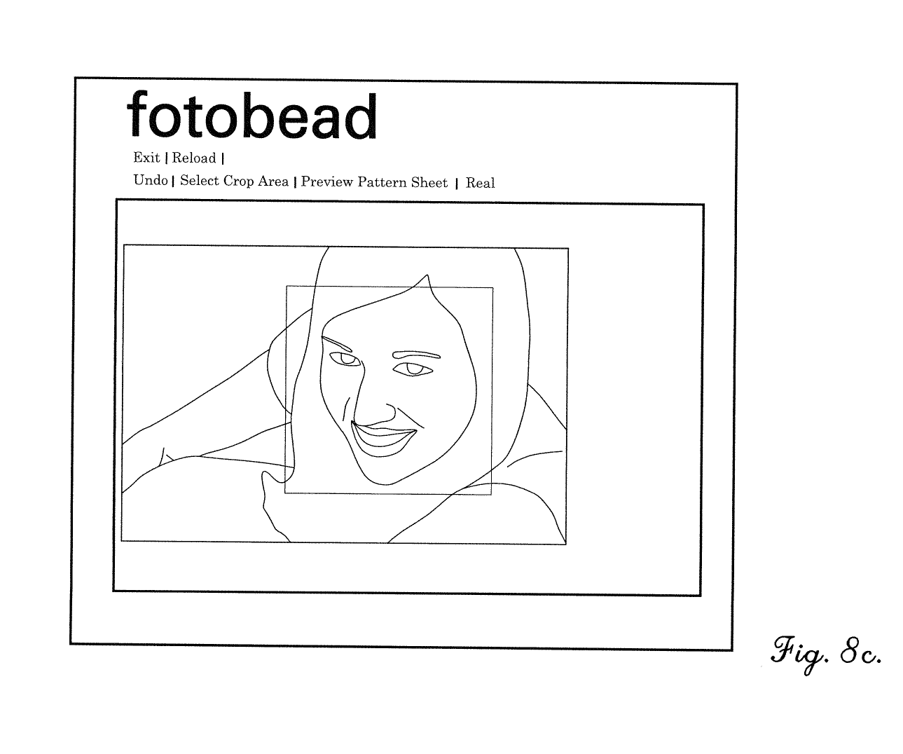

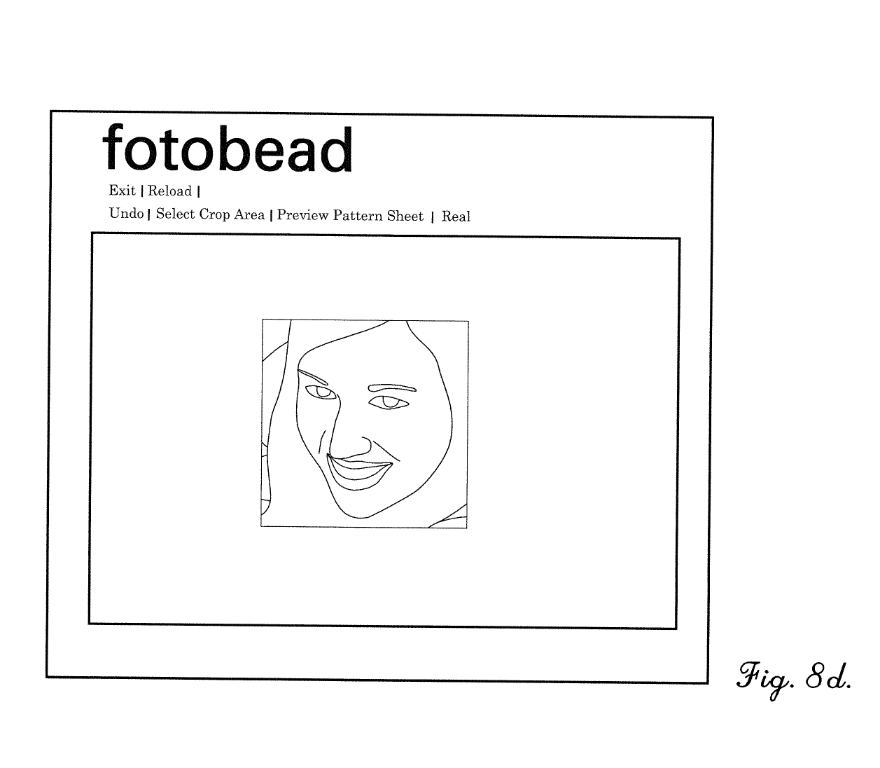

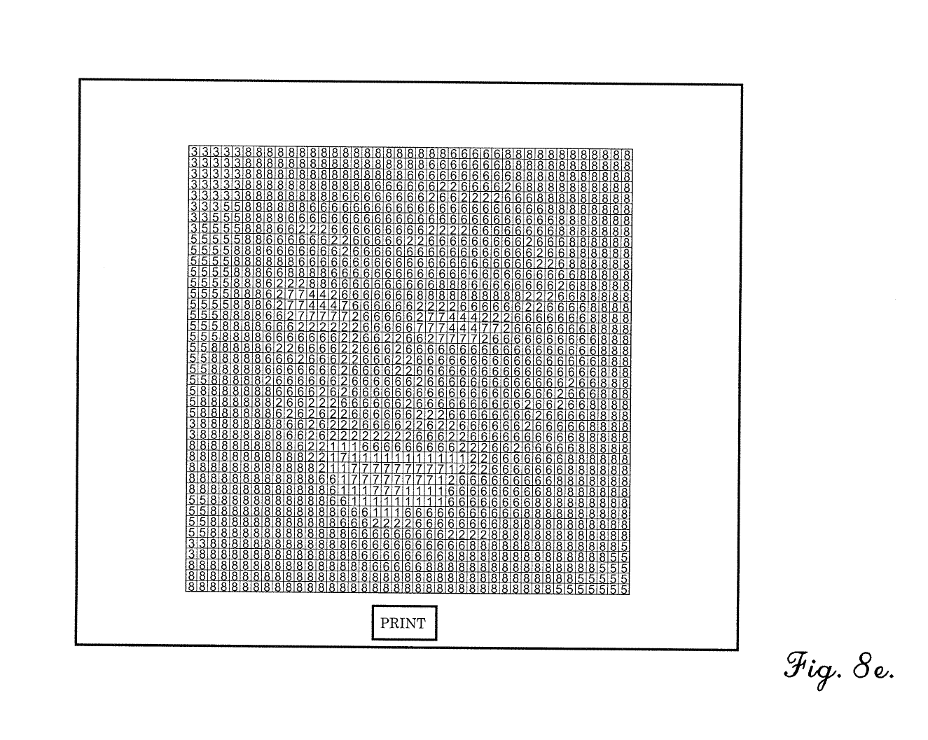

An exemplary website for enabling users to access the software is illustrated in FIG. 8. FIG. 8a illustrates a first page 120 wherein the service is presented and a button 122 for uploading an image to the website. FIG. 8b illustrates a preview of an uploaded image, and FIG. 8c illustrates a selected portion of the image for cropping, the cropped portion being selected by a user or automatically by the software. FIG. 8d illustrates the cropped portion of the image separate from the remainder of the image. FIG. 8e illustrates a page of the website including a preview of the template, wherein numbers on the template correspond to bead colors in the craft kit 34. As explained above, the craft preview may include a preview of the template (illustrated), a preview of the finished craft (not illustrated) by displaying images of beads in their locations corresponding to the template, or both. The webpage illustrated in FIG. 8e further includes a print button 124 for enabling the user to print the template directly from the website.

As described, craft kit 34 may be obtained in a retail store or via an online retailer and the user of the craft kit may upload an image to a website associated with the craft kit. In an alternate embodiment of the invention, a camera is located at a physical retail location (such as a physical retail store, a craft booth at an indoor or outdoor craft fair, craft show, or arts and crafts festival, or a cart or kiosk in or at a shopping mall) at which craft kit 34 may be purchased. Using the camera, a digital photograph of the user of the craft kit is taken. From the digital photograph, a template for making the beaded portrait according to the present invention is generated using software on a computer located at the physical retail store or by uploading the digital photograph to the website described herein. The generated template is printed and may be provided to the purchaser of the craft kit and even placed in the frame as a service to the purchaser. It will be understood that this embodiment may involve self-service, wherein the photograph may be taken by the purchaser and the purchaser using a computer to generate the template or, alternatively, a staff person working at the retail location may take the photograph and take steps to have the template generated by the software of the present invention.

The software may use statistical analysis to optimize the collection of beads that is included in the craft kit 34. By way of example, the software may track the number of beads of each color that are included in each template, the color of the image pixels, or both. If the software identifies a trend of certain bead colors being underutilized, the craft kit 34 may be adjusted to include fewer beads of those colors. Similarly, if the software identifies a trend of insufficient numbers of certain bead colors, the craft kit 34 may be adjusted to include more beads of those colors.

Furthermore, the craft kit 34 may be changed to include new bead colors if, for example, software determines that the new bead colors would more closely match the color of the pixels in the image. Although it will be appreciated that images uploaded to a website corresponding to the present invention may be stored on storage media, in accordance with one embodiment of the invention, only statistical data indicative of an image, and not the image itself, is stored (for example, the image itself can be deleted upon closure of a browsing session at the website).

Although the invention has been described with reference to the exemplary embodiments illustrated in the attached drawings, it is noted that equivalents may be employed and substitutions made herein without departing from the scope of the invention as recited in the claims. For example, the bead container 36 may take virtually any form, including, for example, the container illustrated in FIG. 10 with compartments including ramped floors for facilitating removal of the beads from the compartments.

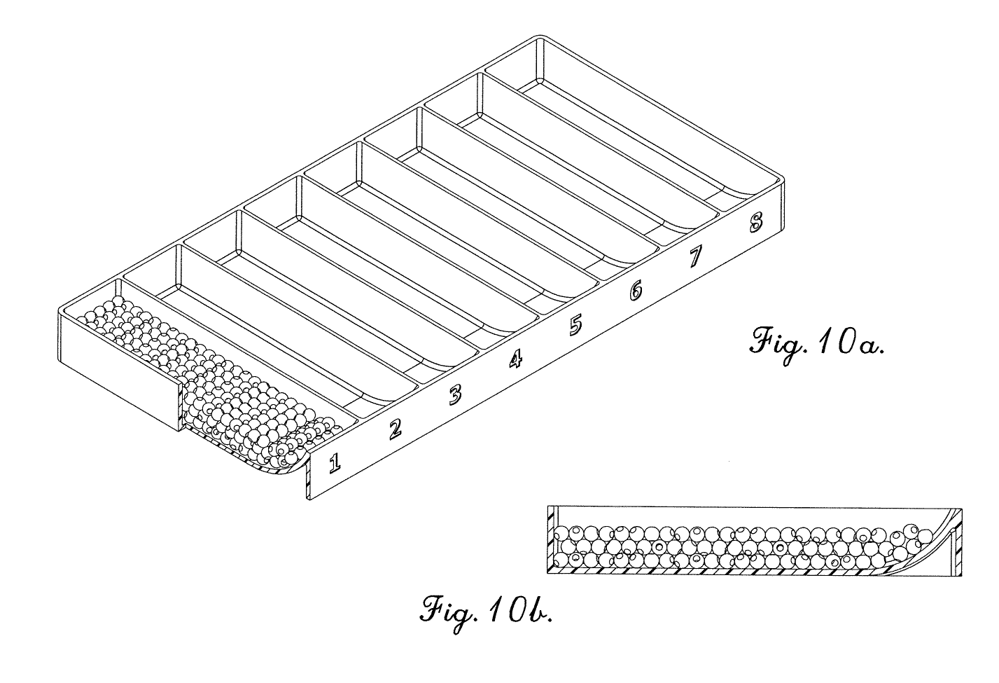

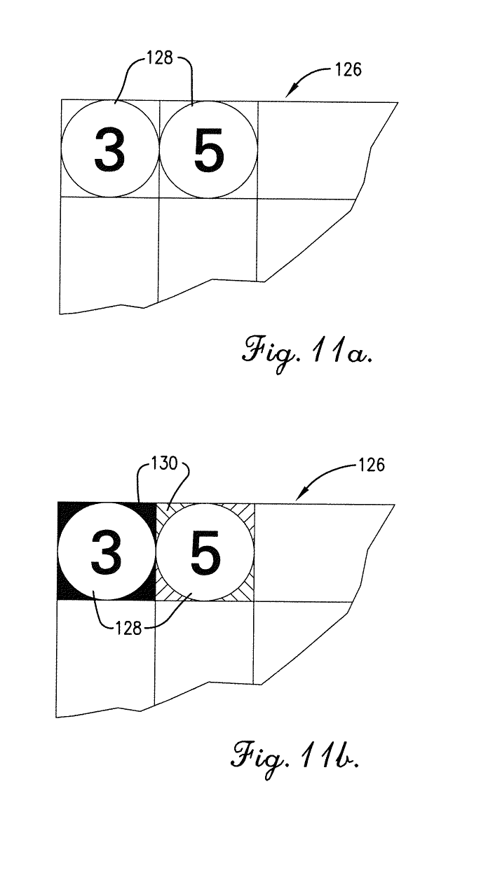

Additionally, as illustrated in FIGS. 11a and 11b, the template, such as illustrated by template 126, includes printed circles 128 indicating locations at which to place beads. Each circle 128 may be represented by a solid line, as illustrated, or a dashed or dotted line, and may have a numerical bead identifier located within the circle. The coloration of the printed circle 128 may correspond to the coloration of the bead to be located at that position. Additionally, the printed circle 128 may be printed faintly. Preferably, each printed circle 128 has a diameter that matches or approximates the dimension of the beads used on the craft. Printed circles 128 serve as guides for placement of the beads and aid the user in keeping the rows and columns of the beads in straight alignment.

Additionally as illustrated in FIG. 11b, the area around a printed circle 128 and corresponding to the diameter of the bead to be located at that location may be shaded, as represented by reference numeral 130. This shading may be in a color corresponding to the bead to be located at that location. Such shading further visually aids the user in bead placement and also fills in the gaps between beads with color. Although this embodiment has been described with a circular bead guide, it will be understood that other shapes could be utilized. Additionally, for example, the bead guide indicia could be a centered cross mark, x-mark, star, or asterisk centered at the location for the bead, preferably with a dimension matching or approximating the bead so that proper placement of the bead will fully cover the marking.

Additionally, it will be understood that other embodiments may be made without departing from the invention. For example, a template generated using the software of the present invention could be printed on fabric, canvas or vinyl that could be used for clothing, handbags, apparel, etc. Additionally, rather than using beads to complete the craft, liquid that sets like a bead, such as colored glues, could be used, particularly for use in an embodiment of the invention on fabric. In an alternate embodiment, the craft could be completed using colored stamps, having tips that are preferably sized and shaped in the desired size, or using colored markers. In an alternate embodiment, the template could be generated on fabric for thread and needle craft to enable a crafter to stitch colored threads in corresponding locations on the template.

Having thus described various embodiments of the invention, what is claimed as new and desired to be protected by Letters Patent includes the following:

1. A method of generating a template for a craft kit, the method comprising:
receiving a plurality of bead color values and a number associated with each bead color value, each number corresponding to a maximum number of beads of that bead color value to be used in the template;
receiving an image;
selecting a pixel from the image and identifying one of the plurality of bead color values that has an associated number greater than zero and is closest in color to a color of the selected pixel;
assigning the identified bead color value to the selected image pixel;
reducing by one the number associated with the identified bead color value; and
generating a template with the identified bead color value indicated in a position on the template corresponding to a position of the pixel in the image.

2. The method of claim 1, further comprising adjusting the image such that the image includes a number of pixels corresponding to a total number of bead positions on the template.

3. The method of claim 1, wherein generating the template document involves generating an electronic image file.

4. The method of claim 1, wherein generating the template document involves printing a physical copy.

5. The method of claim 1, further comprising enabling a user to manipulate the image prior to selecting the pixel from the image.

6. The method of claim 1, wherein identifying one of the plurality of bead color values that has an associated number greater than zero and is closest in color to a color of the selected pixel includes identifying a set of the bead color values with corresponding numbers greater than zero and comparing each of the bead color values corresponding to the set to the color of the selected pixel to determine which of the bead color values corresponding to the set is closest in color to the color of the selected pixel.

7. The method of claim 1, including receiving between six and ten bead color values.

8. The method of claim 1, further comprising determining a difference between the color of the selected image pixel and the identified bead color value, and dispersing the difference to at least one neighboring image pixel.

9. The method of claim 8, wherein dispersing the difference to at least one neighboring image pixel includes adjusting a target color of the neighboring pixel to offset the difference.

10. The method of claim 1, wherein generating the template further comprises generating a template having a visible guide corresponding to the position on the template, wherein the visible guide is at least approximately of a dimension corresponding to the bead to be located at the position.

11. The method of claim 10, wherein the visible guide comprises a circle and generating the template further comprises generating a template having shading in an area outside of the circle and corresponding to a diameter of the circle.

12. A method of generating a template for a craft kit, the method comprising:
(a) establishing a plurality of bead color values and a number associated with each bead color value, each number corresponding to a number of beads of the associated bead color value to be used with the template;
(b) receiving dimension information of a bead array;
(c) receiving an image;
(d) adjusting the image so that each of a plurality of image pixels corresponds to a bead of the bead array;
(e) identifying a subset of the bead color values that have associated numbers greater than zero;
(f) selecting an image pixel and identifying one of the plurality of bead color values from the subset that is closest in color to a color of the selected image pixel;
(g) assigning the identified bead color value to the selected image pixel;
(h) reducing by one the number associated with the identified bead color value;
(i) performing steps (e) through (h) for each of the plurality of image pixels; and
(j) generating a template document with each of the assigned bead color values indicated in a position in the template document corresponding to a position of the associated pixel in the image.

13. The method of claim 12, wherein generating the template document involves printing a paper copy of the document.

14. The method of claim 12, further comprising
(k) receiving a second image;
(l) using the plurality of bead color values and associated numbers established in step (a), performing steps (d) through (i) with respect to the second image; and
(m) generating a second template document with each of the assigned bead color values indicated in a position in the second template document corresponding to the position of the image pixel associated with the bead color value.

15. The method of claim 14, further comprising:
(n) storing statistical information indicative of the received first and second images, wherein said storing statistical information comprises storing information indicative of the bead color values of the first and second images; and
(o) adjusting the maximum number of beads for at least one of the bead color values based upon the statistical information.

16. The method of claim 12, the step of establishing a plurality of bead color value includes establishing eight bead color values.

17. The method of claim 12, further comprising
(g1) determining a difference between the color of the selected image pixel and the identified bead color value, and dispersing the difference to at least one neighboring image pixel by adjusting a target color of the neighboring pixel to offset the difference.

18. A method of enabling assembly of a bead craft, the method comprising:
providing a kit including
a collection of beads including beads of each of a plurality of colors with a pre-selected, fixed number of beads of each color, and
a frame for assembling a bead array from the collection of beads;
after providing the craft kit, processing an image for use in generating a bead template document, the image provided by a craft kit user;
generating the bead template document for enabling assembly of the bead array on the frame, the template document generated by
assigning a bead color to each of a plurality of bead positions on the template document to create a representation of the image using only beads from the collection of beads in the craft kit, and
including a bead color indicator in each of the positions on the template document corresponding to the assigned bead color; and
transferring the bead template document to the user.

19. The method of claim 18, further comprising providing a website accessible by the user for receiving the image, generating the craft template, and transferring the craft template document to the user.

20. The method of claim 18, the collection of beads including beads of eight colors.

21. The method of claim 18, the kit further including a bead color indicator key for identifying a bead color corresponding to each bead color indicator in the template document.

22. The method of claim 18, further comprising providing, as part of the kit, a set of instructions and a container of adhesive for attaching the beads to the frame window.

23. The method of claim 18, the step of generating the bead template document further including
receiving a plurality of bead color values and a number associated with each bead color value, each number corresponding to a number of beads of that bead color value to be used in the template;
selecting a pixel from the image and identifying one of the plurality of bead color values that has an associated number greater than zero and is closest in color to a color of the selected pixel;
assigning the identified bead color value to the selected image pixel; and
reducing by one the number associated with the identified bead color value.

24. A bead craft kit for making a bead craft, the bead craft kit comprising:
a plurality of sets of beads, each set of beads having a color;
a bead container having a lid, the bead container being divided into compartments with each compartment containing beads of the same color, each compartment having a depth and the beads in each compartment filling only a portion of the depth of their corresponding compartment, thereby leaving a space at the top of the compartment;
a frame having a window pane;
a container of adhesive;
instructions for completing the bead craft, the instructions including particular instructions to upload a digital image to a website associated with the bead craft kit; and
a template generated and printed via the website, the template corresponding to a digital image uploaded to the website and having a plurality of identified locations for identifying placement of beads from the plurality of bead sets, each identified location having an identifier for identifying a particular colored bead to be placed at the location and each identified location having a circular guide for identifying proper placement of a bead and further having a shaded area outside of the circular guide in an area corresponding to the diameter of the circular guide.

25. The bead craft kit of claim 24, wherein at least a portion of the beads are translucent, the template is transparent, and the frame includes a back that is at least partially transparent.

26. The bead craft kit of claim 24, wherein the compartments in the bead container are arranged in an array and a central area in said array comprises a label including a key for identifying each of said bead sets.

27. A method for providing a bead craft kit that is used to create a bead craft, the method comprising:
providing a digital camera at a physical retail location;
providing access at the retail location to software that uses a digital image to generate a template for use in a craft;
taking a photograph of a person with the digital camera at the physical retail location;
generating a template based upon the digital image, wherein the template has a plurality of identified locations each including an identifier for identifying a particular colored bead to be placed at the location; and
providing to the person at the physical retail location the template, a plurality of colored beads, a frame having a window pane, and instructions for completing the bead craft, wherein the instructions indicate gluing the colored beads to the window pane corresponding to identified locations on the template.

28. The method as set forth in claim 27, further comprising:
providing glue to said person at said physical retail location; and
providing a visual preview of how said finished bead craft will appear at said retail location.
